(19) United States
(12) Patent Application Publication
(10) Pub. No.: US 2012/0079009 A1
(43) Pub. Date: Mar. 29, 2012

(54) METHOD AND APPARATUS FOR CHOOSING RESOURCES BASED ON CONTEXT AND INHERITANCE

(75) Inventors: Wayne Carter, Salt Lake City, UT (US); Sridhar Tadepalli, Foster City, CA (US); Rahim Yaseen, Redwood City, CA (US)

(73) Assignee: Oracle International Corporation, Redwood Shores, CA (US)

(21) Appl. No.: 13/236,371

(22) Filed: Sep. 19, 2011

Related U.S. Application Data
(60) Provisional application No. 61/384,150, filed on Sep. 17, 2010.

(51) Int. Cl. G06F 15/16

(52) U.S. Cl. 709/203

(57) ABSTRACT

A method and apparatus for choosing resources based on context and inheritance. In one embodiment of the method, a computer system receives a page request from a mobile device, wherein the page request comprises data that identifies a mobile device type. In response to receiving the page request, the computer system selecting a page definition, wherein the page definition comprises one or more resource identifiers. The computer system selects a first identifier from the one or more identifiers. The computer system creates a list of keys, wherein each key of the list is distinct from the other keys in the list, and each key of the list is created as a function of the first identifier and the data or a portion thereof. The computer system accesses a memory structure that directly or indirectly maps resources to respective keys. The computer system selects a first key from the list, and compares the first key with keys in the memory structure. The computer system selects a first resource that is mapped directly or indirectly to a key in the memory structure that matches the first key. The computer system generates a reply to the request, wherein the reply comprises the first resource.

### CROSS-REFERENCE TO RELATED APPLICATIONS

This application claims priority to Provisional Application No. 61/384,150 filed on Sep. 17, 2010, and is incorporated herein in its entirety by reference.

### BACKGROUND OF THE INVENTION

Enterprise applications are integral parts of many businesses and provide valuable services to its users. For example, enterprise applications provide customer relationship management (CRM), resource planning, human resource management, etc. The present invention will be described with reference to an example CRM that provides sales and marketing services to its users, it being understood that the present invention should not be limited thereto.

CRM is a widely implemented strategy for managing a company's interaction with customers, clients, and sales prospects. CRM involves technology to organize, automate, and synchronize business processes-principally sales activities, but also those for marketing, customer service, and technical support. The overall goals of CRM are to find, attract, and win new clients, nurture and retain those the company already has, etc.

CRM services can be accessed through mobile devices (e.g., smart phones or tablet computers) in data communication with a data processing system the implements the CRM. The present invention will be described with reference to providing CRM services to users via their mobile devices, it being understood that the present invention should not be limited thereto.

### SUMMARY

A method and apparatus for choosing resources based on context and inheritance. In one embodiment of the method, a computer system receives a page request from a mobile device, wherein the page request comprises data that identifies a mobile device type. In response to receiving the page request, the computer system selecting a page definition, wherein the page definition comprises one or more resource identifiers. The computer system selects a first identifier from the one or more identifiers. The computer system creates a list of keys, wherein each key of the list is distinct from the other keys in the list, and each key of the list is created as a function of the first identifier and the data or a portion thereof. The computer system accesses a memory structure that directly or indirectly maps resources to respective keys. The computer system selects a first key from the list, and compares the first key with keys in the memory structure. The computer system selects a first resource that is mapped directly or indirectly to a key in the memory structure that matches the first key. The computer system generates a reply to the request, wherein the reply comprises the first resource.

### BRIEF DESCRIPTION OF THE DRAWINGS

The present invention may be better understood, and its numerous objects, features, and advantages made apparent to those skilled in the art by referencing the accompanying drawings.

FIG. 1 graphically illustrates relevant components of an example system that employs mobile CRM.

FIG. 2 graphically illustrates relevant components of an example server employed in FIG. 1.

FIGS. 3-5 graphically illustrate external components of example mobile devices employed in FIG. 1.

FIGS. 6-8 graphically illustrate external components of example mobile device employed in FIG. 1.

FIGS. 9-11 graphically illustrate external components of example mobile devices employed in FIG. 1.

FIG. 12 graphically illustrates relevant components of an example serialization system.

FIG. 13 graphically illustrates relevant aspects of a process employed in the server of FIG. 1.

FIG. 14 is a block diagram of an example computer system that may be employed in the system of FIG. 1 or 2.

The use of the same reference symbols in different drawings indicates similar or identical items.

### DETAILED DESCRIPTION

Today's sales and marketing workforce is more mobile than ever. To reduce sales downtime, increase customer face time, and win more deals, many companies now employ mobile CRM to move their business forward while employees are on the road. Mobile CRM enables users to more efficiently use CRM services such accessing, reviewing, and/or updating sales opportunities, contacts, leads, calendar entries, etc., through user interfaces (UIs) or pages displayed on their mobile devices.

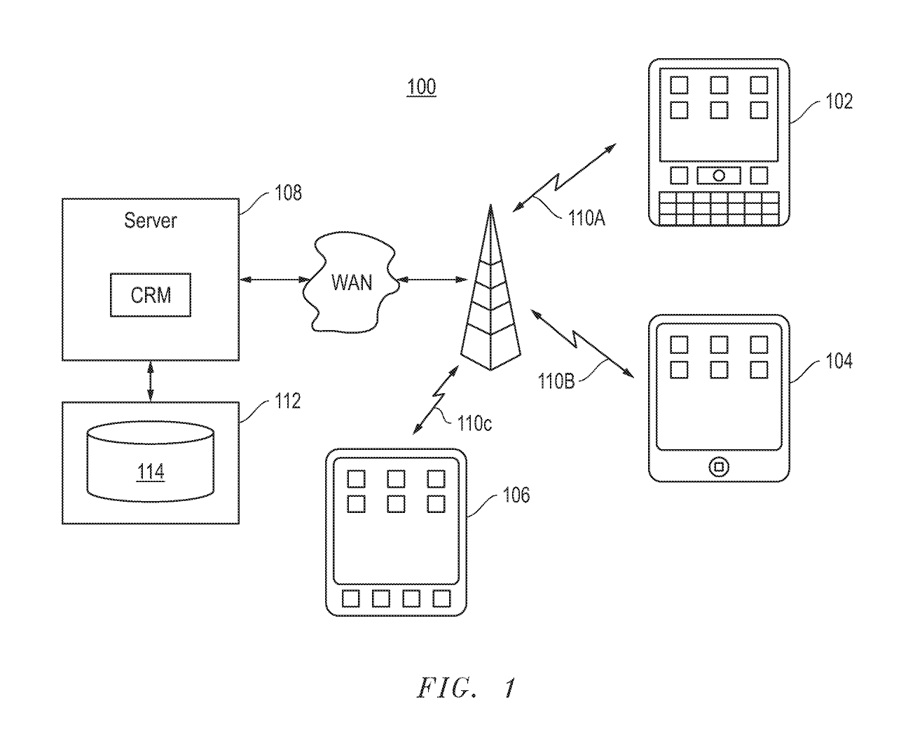

FIG. 1 illustrates in block diagram form, relevant components of an example system 100 that implements mobile CRM in accordance with one embodiment of the present invention. System 100 includes mobile devices (e.g., smart phones) 102-106 in wireless communication with a CRM executing on server 108. The CRM is in data communication with a storage system 112 that includes one or more relational databases 114. For purposes of explanation only, storage system 112 is presumed to include a single relational database 114.

Relational database 114 stores data of a logical data model, which in turn consists of business objects. A business object may represent a logical entity that stores a set of instance variables or properties, also known as attributes, and associations with other business objects, thereby weaving a map of objects representing business relationships. A business object may represent a data entity that may contain related data held in many tables of the relational database 114. A business object may be made of business components that map to these tables. A business object is an object type that glues related business components together. A business component is said to provide a layer of wrapping over the tables. Opportunities, accounts, and contacts are examples of business objects.

As will be more fully described below, the CRM of FIG. 1 operates with mobile devices 102-106, which are substantially different in design and operation. In other words, the CRM is designed to be mobile device independent. The CRM includes a single, metadata driven application that contains multiple views or page definitions. As will be more fully described, in response to receiving a page request from a mobile device, the CRM first selects an appropriate page definition that is needed to form a reply to the request. The CRM may merge or bind data of a logical data model with the selected page definition, and select mobile device dependent resources. The CRM generates a reply that contains the page definition merged with data and/or the selected resources. The reply is subsequently serialized and sent to the requesting mobile device. Serialization is the process of converting a data structure or object state into a format that can transmitted across a network communication link and “resurrected” later in another device such as one of the mobile devices 102-106. The mobile device receives the reply, deserializes content contained therein, and subsequently displays a page that includes visual representations of the merged data and other components such as images or icons.

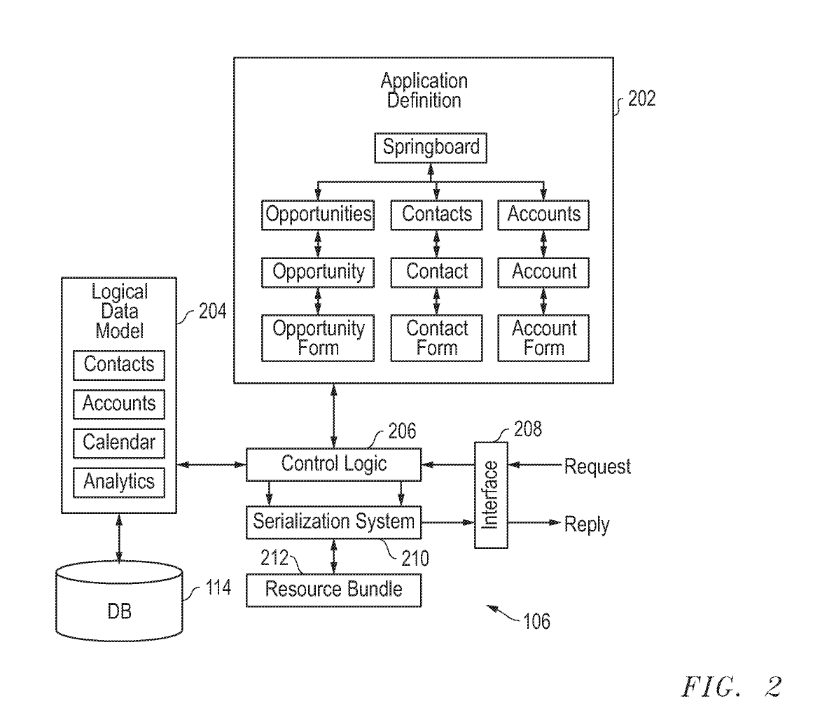

The CRM implements a model-view-controller architecture. With continuing reference to FIG. 1, FIG. 2 illustrates an example of server 108 from FIG. 1 with relevant components shown in block diagram form. Memory 202 stores an application definition for the CRM. The application definition includes page definitions, some of which are visually represented along with navigation flow relationships therebetween. Page definitions (also known as “views”) form the basis of pages that are displayed by mobile devices 102-106. Each of the page definitions can be used to render a page on any or all of mobile devices 102-106. The application definition can be built using Java Server Faces (JSF) technology, it being understood the present invention should not be limited thereto. JSF provides standard, reusable components for creating pages that can be displayed on mobile devices. JSF provides useful, special tags to enhance page definitions. Each tag gives rise to an associated component. JSF can also be used to define page navigation within the application definition, map page components to a data model, identify resources to be employed by the mobile devices, etc. While page definitions run on server 108, they are displayed on mobile devices 102-106. Example page definitions are visually represented. The “springboard” page definition can be used to render a page with icons arranged in a two-dimensional pattern. Each icon may represent a mini-application or high level business object within the logical data model. The “accounts,” “opportunities,” and “contacts” page definitions can be used to render pages with names or other information of accounts, opportunities, and contacts, respectively, in a list pattern. The “account,” “opportunity,” and “contact” page definitions can be used to render pages with data from an account, opportunity, and contact, respectively, in a form pattern. The “account form,” “opportunity form,” and “contact form” page definitions can be used to render pages with data from an account, opportunity, and contact, respectively, in a user editable form pattern. Other page definitions in memory 202 are contemplated.

Page definitions can be used to render logical data model 204 into a form suitable for interaction by a user of a mobile device via a page displayed thereon. Logical data model 204 manages the business object data of the application definition, responds to requests for information about its state (usually from a page definition), and responds to instructions to change state from control logic 206. In one sense, logical data model 204 provides access to business objects such as contacts, opportunities, analytics, etc. The logical data model 204 is both the data and the business/domain logic needed to manipulate the data of the application definition.

Control logic 206, which may take form in instructions executing on a processor, is in data communication with the application definition contained within memory 202 in addition to being in data communication with interface 208 and serialization system 210. Control logic 206 can receive a page request from any of the mobile devices 102-106 via interface 208. In response to receiving the page request, control logic 206 may access the application definition in memory 202 to identify and retrieve an appropriate page definition, or relevant components thereof, which is needed to form the proper reply. The page definition retrieved from memory 202 is based on information contained in the page request and may contain metadata that is used to retrieve data of the logical data model 204. The page definition may also include resource identifiers that are used to retrieve mobile device dependent resources, such as icons, images, labels, flow control, text, etc. Text is an example of a resource that varies with the mobile device. For mobile device 104 a ‘+’ can be used as text to indicate a create action, and for mobile device 102 the term ‘New’ can be used for the same action. Resources can be stored and used at the server side to render images in real-time of a certain height and width depending on the requesting mobile device. One type of image that is rendered this way is an image that shows real-time data in a pie/line/bar/etc chart.

Control logic 206 can make calls on business objects of logical data model 204 to retrieve the data needed by the page definition. Serialization system 210 can bind or merge the page definition with data retrieved from model 204. Serialization system 210 can also select resources (e.g., icons, images, labels, flow control, etc.) from resource memory 212 that are needed by the selected page definition based on the type of mobile device that sent the page request. Serialization system generates a reply from the selected resources and/or the result of binding the selected page definition with data from model 204. Serialization system 210 subsequently serializes the reply for transmission to the requesting mobile device.

The page definitions in memory 202 are independent of mobile device, which allows the page definitions to be used as a basis for creating a reply for any mobile device 102-106 requesting a page. Resources (e.g., icons, images, labels, flow control, etc.) can be selected and added to the reply. Different types of mobile devices work better with different resources. Replies sent to mobile devices 102-106 should include resources that are optimal for the mobile device type. Therefore, serialization system 210 should know the type of mobile device that requested the page before serialization system 210 retrieves resources for the corresponding reply. To accommodate this feature, each page request should identify the target mobile device by type. Each request can identify the type of mobile device in terms of: a manufacturer of the mobile device, a product line of the manufacturer, a product within the product line, and/or a version of the product. In one embodiment, the mobile device type (hereinafter referred to as the “context”) can be expressed as a concatenation of: a manufacturer of the mobile device, a product line of the manufacturer, a product within the product line, and/or a version of the product. Two or more mobile devices may be the same type, and should receive the same resources in a serialized reply to the same request. Separate mobile devices with distinct types may receive serialized replies created from the same page definition, but with distinct sets of resources.

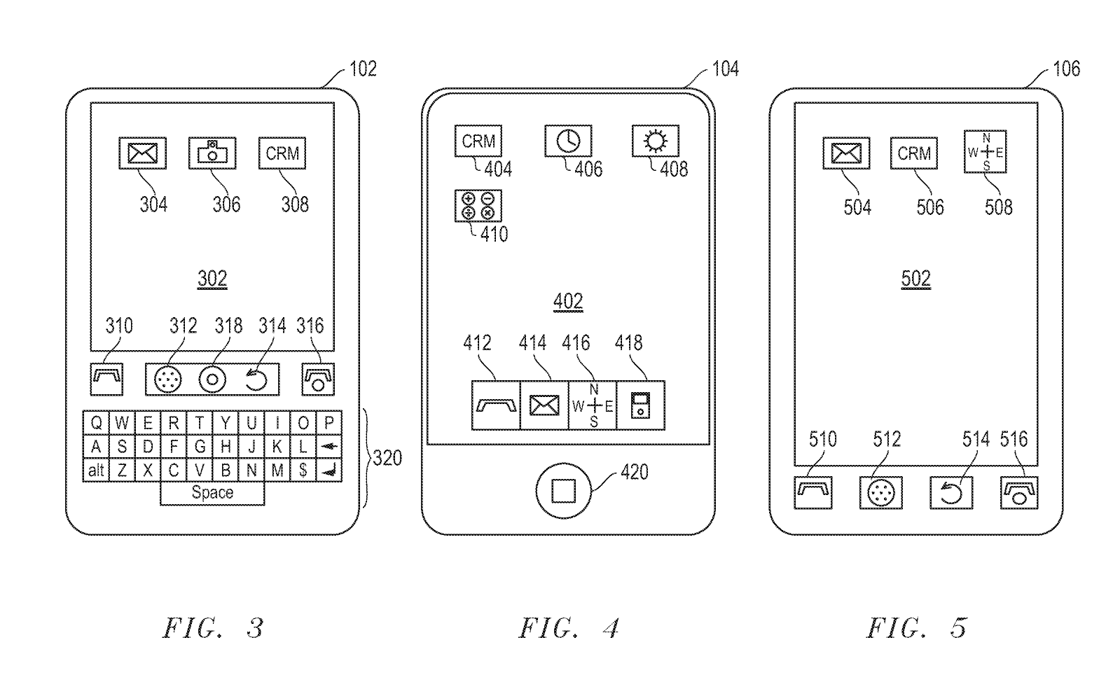

With continuing reference to FIG. 2, FIGS. 3-5 illustrate relevant external features of mobile devices 102-106. Each of mobile devices 102-106, although different in design and operation, can implement common functions such as email, cell phone, etc. FIGS. 3-5 illustrate several distinctions between mobile devices 102-106. Mobile device 102 includes a hard or physical keyboard, while mobile devices 104 and 106 include soft keyboards (not shown). Mobile devices 104 and 106 may include soft buttons displayed on a touch sensitive display screen. Mobile device 102 lacks a touch sensitive screen. Rather, mobile device 102 includes a trackball and multiple, dedicated physical buttons. Although different in many aspects, mobile devices 102-106 are sized to fit in the front or back pocket of a normal pair of adult sized pants, it being understood that the term mobile device should not be limited thereto.

With continuing reference to FIG. 2, mobile device 102 as shown in FIG. 3 includes a screen 302 that displays active icons corresponding to different applications including icon 308, which corresponds to the CRM executing on server 108. In addition, mobile device 102 includes physical buttons 310-316, a trackball 318, and a physical keyboard 320. A trackball is a pointing device consisting of a ball held by a socket containing sensors to detect a rotation of the ball about two axes—like an upside-down mouse with an exposed protruding ball. The user rolls the ball with the thumb, fingers, or the palm of the hand to move a cursor across screen 302 to reach active buttons or icons. When the curser reaches an active button or icon, the user can activate the button or icon by depressing trackball 318. Another native feature of mobile device 102 is the display of a menu on screen 320 when the trackball is depressed.

In contrast, mobile device 104 in FIG. 4 lacks multiple, dedicated physical buttons, a trackball, and a physical keyboard. Rather, mobile device 104 has a single physical button 420 and a touch sensitive display screen 402 with active icons 404-408 displayed therein. Like the icons shown in FIG. 3, the icons shown in FIG. 4 correspond to respective applications including icon 404 that corresponds to the CRM executing on server 108. Mobile device 104 in FIG. 4 includes several soft buttons 412-418, but only one physical button 420. A user can activate a soft button or icon by simply by touching it. Although not shown, a soft keyboard can be displayed.

Like mobile device 102, mobile 106 in FIG. 5 includes multiple physical buttons 510-516, but lacks both a trackball and a physical keyboard. Like mobile device 104, mobile device 106 includes a touch sensitive display screen 502 with active icons 504-508 displayed therein. The icons shown in FIG. 5 correspond to respective applications including icon 506 that corresponds to the CRM on server 108. A user can activate a soft button or icon on screen 502 by simply touching it. Although not shown, a soft keyboard can be displayed.

FIGS. 6-8 illustrate relevant internal components of the mobile devices 102-106, respectively, in block diagram form. At first glance, mobile devices 102-106 contain similar components. However, corresponding components in mobile devices 102-106 can operate alone or in conjunction with each other in substantially different ways to produce different results.

With continuing reference to FIG. 6, mobile device 102 includes a memory controller 602 coupled to a processor 604 and a peripherals interface 606. The various components of mobile device 102 may be coupled by one or more communication buses or signal lines 608. The peripherals interface 606 is coupled to radio frequency (RF) circuit 610, audio circuit 612, and global positioning system (GPS) circuit 613. The GPS circuit 613 supports a location determining capability and can provide the longitude and latitude of mobile device 102 upon request.

The peripherals interface 602 is coupled to an I/O subsystem 614 that contains various controllers that interact with other components of mobile device 102. I/O subsystem 614 includes a keyboard controller coupled to receive input from the physical keyboard 320. The trackball controller is coupled to receive input from the trackball 318. And dedicated buttons controllers receive respective inputs from dedicated buttons 310-316.

Memory controller 602 is coupled to memory 618, which may take form in one or more types of computer readable medium. Memory 618 stores several software components or modules including a communication module that provides communication procedures, which enable communication between mobile device 102 and server 108 via a wireless communication link 110A shown in FIG. 1. Memory 618 may also includes a deserializer 622, an operating system 624, and a set of applications including CRM client 626 as shown. Components in memory 618 may support email, texting, mapping, etc. The CRM client 626, as will be more fully described below, operates in conjunction with other modules (e.g., operating system 624, etc.) shown within FIG. 6 to render a page provided by server 108, create a request for a subsequent page, issue instructions to initiate functions such as email, cell phone, etc.

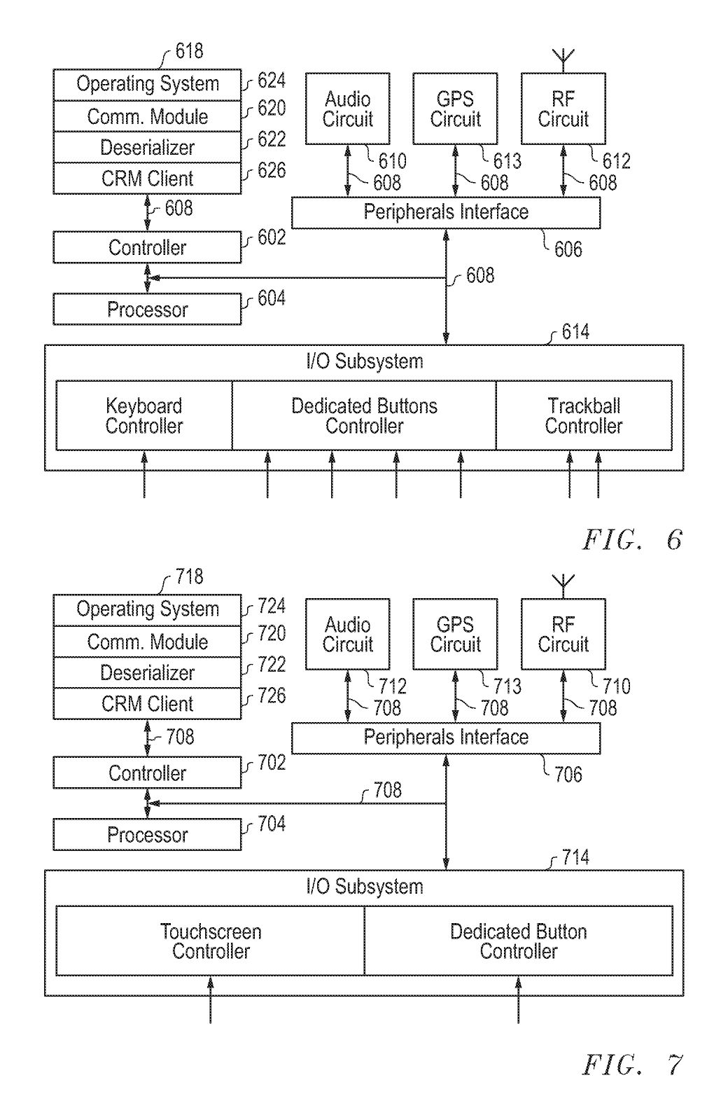

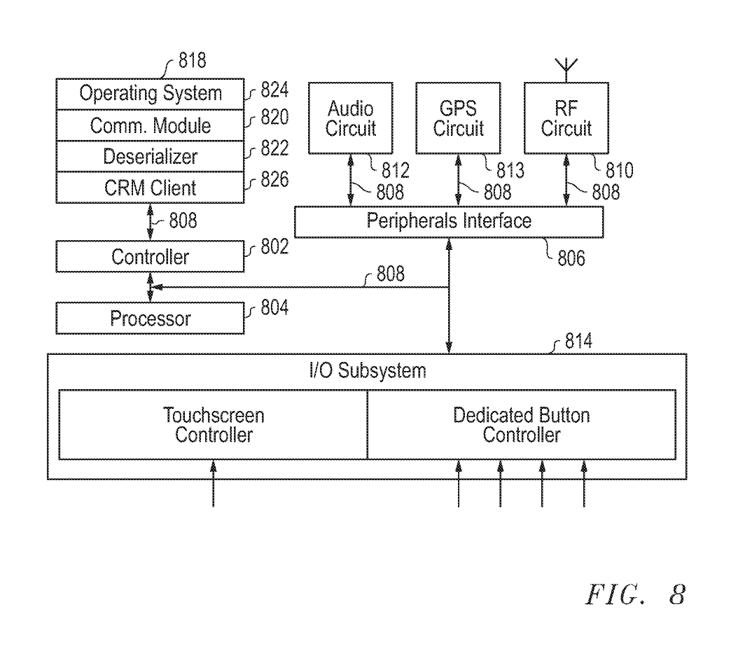

With continuing reference to FIG. 7, mobile device 104 includes a memory controller 702 coupled to a processor 704 and a peripherals interface 706. Like mobile device 102, the various components of mobile device 104 may be coupled by one or more communication buses or signal lines 708. The peripherals interface 706 is coupled to RF circuit 710, audio circuit 712, and global positioning system (GPS) circuit 713, which supports location determining capabilities.

The peripherals interface 702 is coupled to an I/O subsystem 714 that contains various controllers that interact with other components of mobile device 104. I/O subsystem 714 includes a touch screen controller that is coupled to the touch sensitive display screen 404 shown in FIG. 4. The touch screen controller may detect contact and any movement or break thereof.

Memory controller 702 is coupled to memory 718, which may take form in one or more types of computer readable medium. Memory 718 stores several software components or modules including a communication module that provides communication procedures, which enable communication between mobile device 104 and server 108 via wireless communication link 110B shown in FIG. 1. Memory 718 may also include deserializer 722, an operating system 724, and a set of applications including CRM client 726 as shown. Other components in memory 718 may support email service, texting, etc. The CRM client 726, as will be more fully described below, operates in conjunction with modules shown within FIG. 7 to display a page provided by server 108, create a request for a subsequent page, issue instructions to initiate functions such as email, cell phone, mapping, etc.

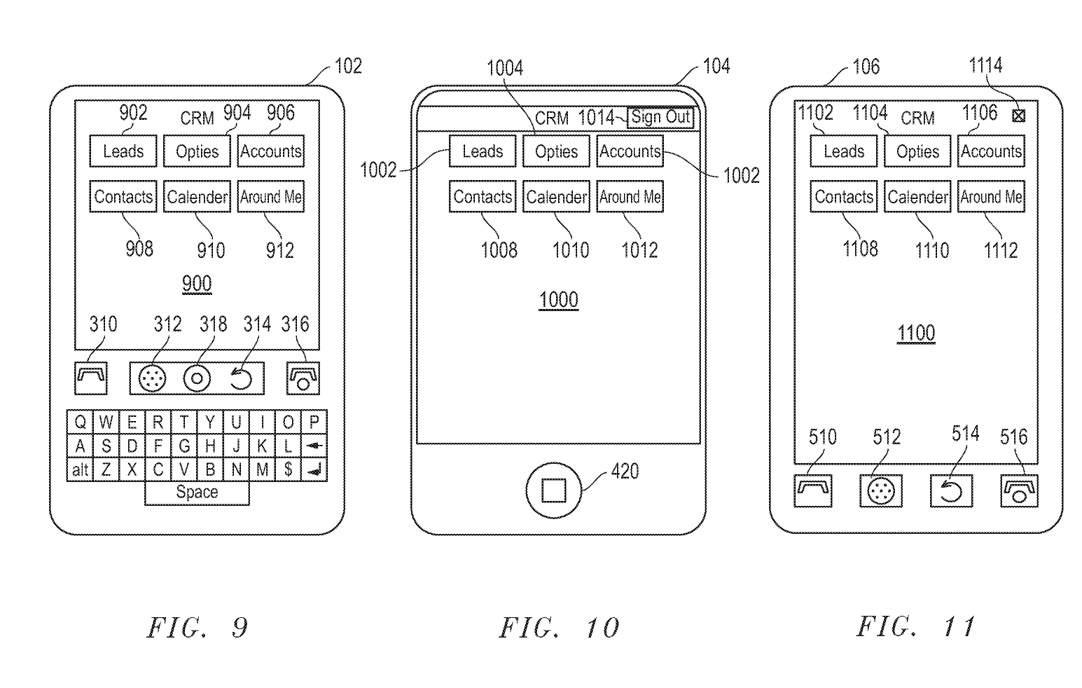

With continuing reference to FIG. 8, mobile device 106 includes a memory controller 802 coupled to a processor 804 and a peripherals interface 806. Like mobile device 102, the various components of mobile device 104 may be coupled by one or more communication buses or signal lines 808. The peripherals interface 806 is coupled to RF circuit 810, audio circuit 812, and global positioning system (GPS) circuit 813, which supports location determining capabilities.

The peripherals interface 802 is coupled to an I/O subsystem 814 that contains various controllers that interact with other components of mobile device 104. I/O subsystem 814 includes a touch screen controller that is coupled to the touch sensitive display screen shown in FIG. 5. The touch screen controller may detect contact and any movement or break thereof.

Memory controller 802 is coupled to memory 818, which may take form in one or more types of computer readable medium. Memory 818 stores several software components or modules including a communication module that provides communication procedures, which enable communication between mobile device 104 and server 108 via wireless communication link 110C shown in FIG. 1. Memory 818 may also include a deserializer 822, an operating system 824, and a set of applications including CRM client 826 as shown. Other components in memory 818 may support email service, texting, etc. The CRM client 826, as will be more fully described below, operates in conjunction with modules shown within FIG. 8 to display a page provided by server 108, create a request for a subsequent page, issue instructions to initiate functions such as email, cell phone, mapping, etc.

CRM clients 826, 626 and 726 are substantially different from each other. The differences between CRM clients enable the same page requested from the CRM to be displayed with a look and feel that is native to mobile devices 102-106 and similar to the look and feel of pages displayed by other applications in memory 618-818, respectively. Look and feel is a term used to describe aspects of page design, including elements such as colors, shapes, layout, typefaces, etc., (the “look”) as well as the behavior of dynamic elements such as buttons, boxes, and menus (the “feel”).

Mobile devices 102-106 display pages on their respective screens using serialized replies received from the CRM. The replies may consist of selected resources and page definitions merged with model data. The page definitions as they exist in memory 202 do not take into account different mobile device features including look and feel. In other words, the page definitions are developed independent of mobile devices including mobile device 102-106.

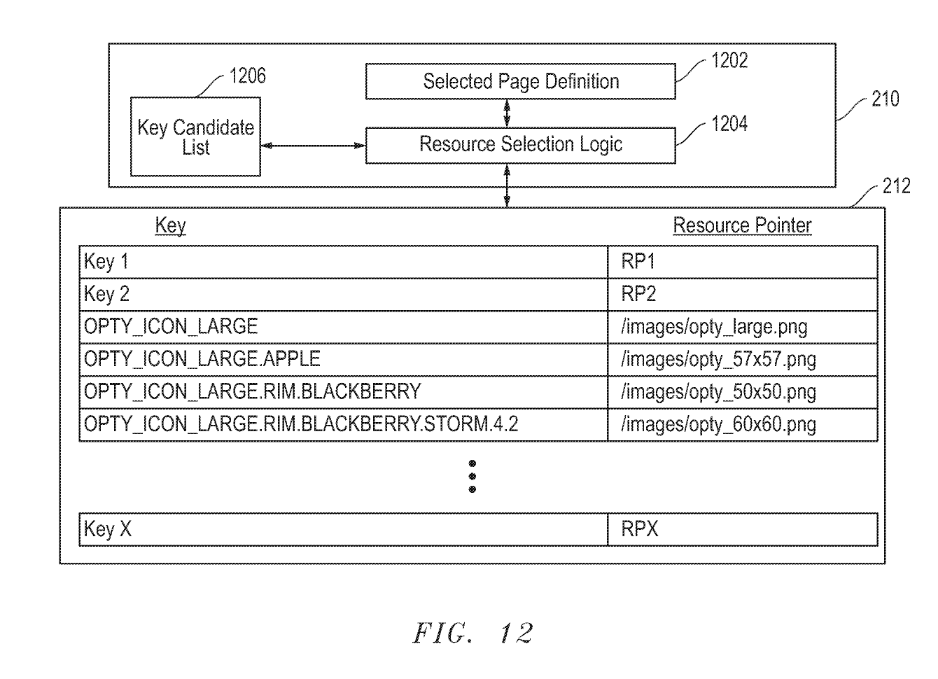

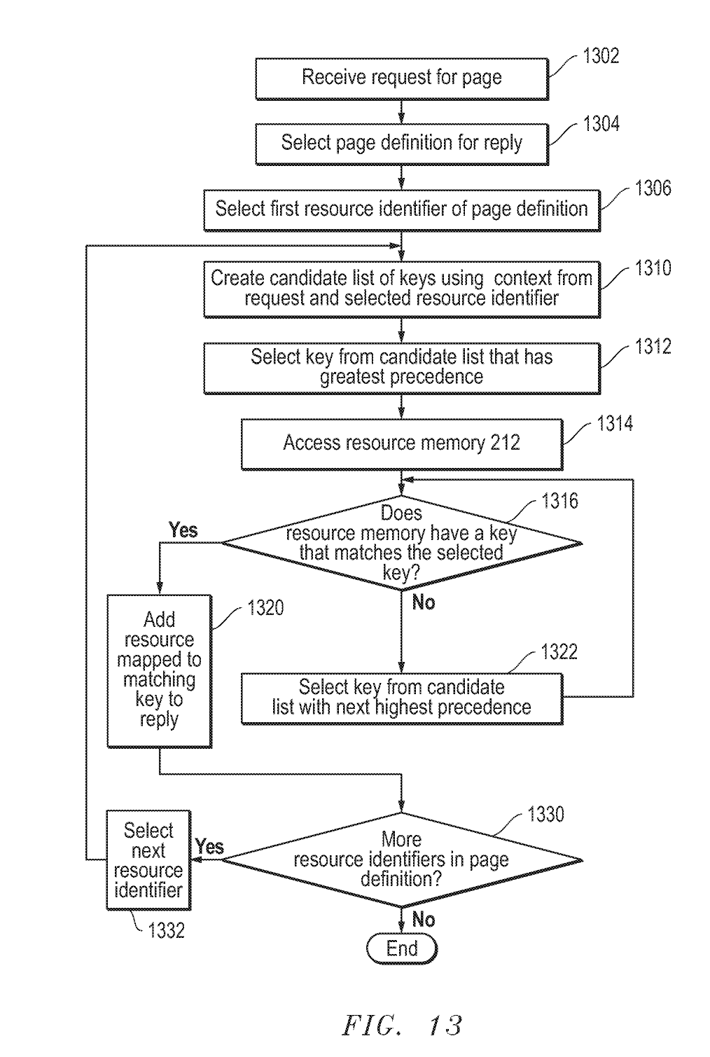

Users of mobile devices 102-106 can initiate respective sessions with the CRM by activating CRM icons 308, 404, and 504, respectively, shown in FIGS. 3-5. In response to activating these icons, mobile devices 102-106 generate and send respective page requests to the CRM. The CRM generates and sends respective replies containing serialized springboard pages. FIGS. 9-11 show mobile devices 102-106 with springboard pages 900-1100, which are displayed after mobile devices 102-106 their respective replies.

There are many clear distinctions between the pages as shown in FIGS. 9-11, even though they are created from the same springboard page definition in memory 202. Many of the differences in the corresponding pages may account for differences in the native look and feel of mobile devices 102-106. For example, page 1000 contains a soft “Sign Out” button that, when activated, ends the user's session with the CRM. Page 1100 has an X-out button 1114 for the same function. Page 900 lacks a button for ending the user's session with the CRM, but the user can end the session by selecting an option from a menu (not shown) that is displayed after trackball 318 is depressed.

Additional distinctions exist with pages 900-1100, although not apparent from the figures. For example, icons 902-912 are rendered using a first set of Portable Network Graphics (PNG) files that were included as resources in the reply received by mobile device 102. PNG files contain data of images that can be used by mobile devices to render the images for display. Icons 1002-1012 are rendered using a second set of PNG files that were included as resources in the reply received by mobile device 104. And icons 1102-1112 are rendered using a third set of PNG files that were included as resources in the reply received by mobile device 106. The icons in FIGS. 9-11 are different by virtue of being rendered from distinct sets of PNG files even though that may not be evident in the figures. For example icons 1002-1012 may have a different resolution, color, size, etc., when compared to icons 902-912 and icons 1102-1112. Resources such as the PNG files above are selected by the serialization system 210 for inclusion in replies sent to mobile devices based on mobile device context as will be more fully described below.

With continuing reference to FIG. 2, serialization system 210 is configured to select resources from resource memory 212 for inclusion in a reply before the reply is serialized and sent to a requesting mobile device. FIG. 12 illustrates in block diagram form, relevant components of serialization system 210 and resource memory 212. Serialization system 210 includes memories 1202 and 1206, each of which is accessible by resource selection logic 1204. Memory 1202 stores a copy of a page definition selected by control logic 206. Memory 1206 stores a key candidate list created by resource selection logic 1204 as will be more fully described. Memory 212 maps keys to respective resource pointers, some of which are shown in FIG. 12. Each pointer points to a respective resource (not shown) in a file that is also stored in memory 212.

Each page request received from a mobile device should include data (hereinafter referred to as a “context”) that identifies the mobile device by type. The context, in one embodiment, represents a concatenation of device manufacturer, product line, product, and/or a version number. Contexts are assigned to mobile devices, but may or may not include each component of the foregoing list.

Example contexts assigned to mobile devices 102-106 are shown below:

Context 102=RIM.BLACKBERRY.BOLD for mobile device 102

Context 104=APPLE.IPHONE for mobile device 104

Context 106=RIM.BLACKBERRY.STORM.4.2 for mobile device 106

In context 106 above, RIM identifies a manufacturer, BLACKBERRY identifies a product line, STORM identifies a product of the product line, and 4.2 identifies a version. The CRM client executing on each of the mobile devices 102-106 should include its assigned context with each page request that it sends to the CRM. To illustrate, the page request generated by mobile device 102 when a user activates icon 306 in FIG. 3, should include RIM.BLACKBERRY.BOLD.

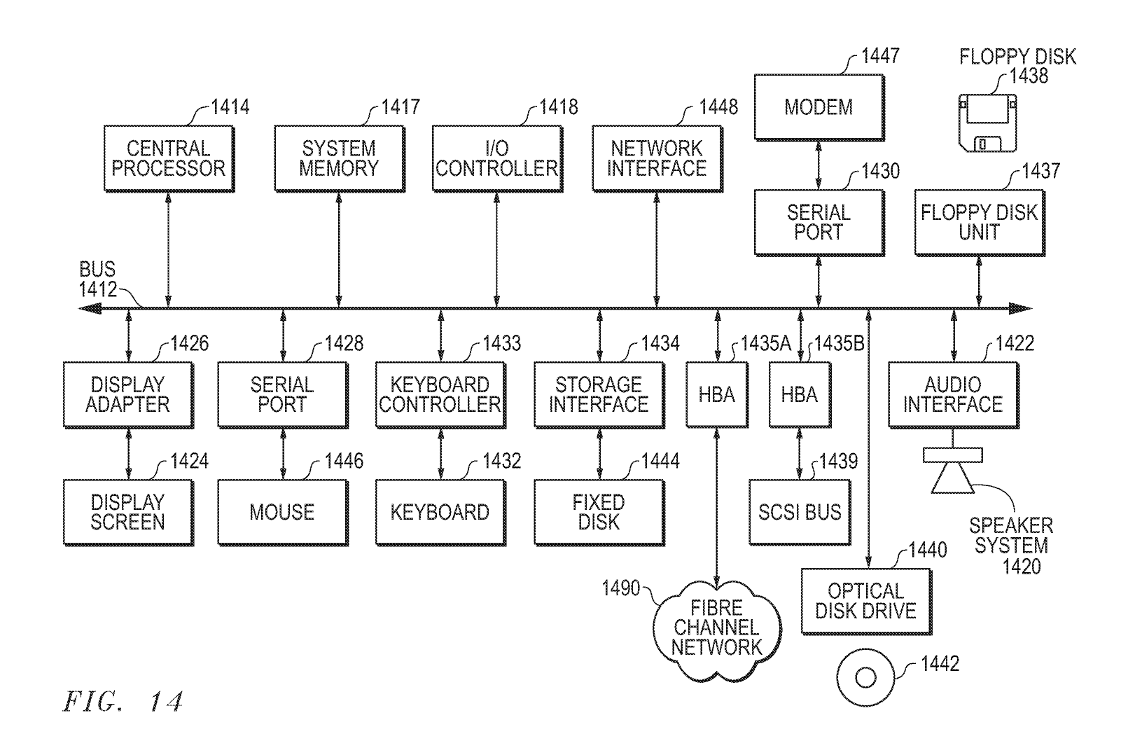

The context is used to select resources for a reply to a page request from one of the mobile devices 102-106. FIG. 13 illustrates relevant aspects of an example method for selecting resources for a reply using the context. With continuing reference to FIG. 12, the method of FIG. 13 starts with step 1302 when control logic 206 receives a request for a page from one of the mobile devices 102-106. For purposes of explanation, FIG. 13 will be described with reference to control logic 206 receiving a page request from mobile device 102 in response to user activation of icon 308 in FIG. 3.

In response to receiving the request, control logic 206 forwards the context (e.g., RIM.BLACKBERRY.BOLD) of the request to serialization system 210. In step 1304, control logic 206 selects the appropriate page definition (e.g., the springboard definition) from memory 202 based on information contained in the request. The page definition selected in step 1304 will be used to create the reply to the request of step 1302. Control logic 206 provides serialization system 210 with a copy of the selected page definition, which in turn is stored within memory 1202 in FIG. 12.

Resource selection logic 1204, which may take form in instructions executing on one or more processors of server 108, has access to the page definition stored within memory 1202 and is configured to locate resource identifiers contained therein. In step 1306, resource selection logic 1204 identifies and selects the first resource identifier (e.g., OPTY_ICON_LARGE) from the page definition stored in memory 1202. In the illustrated example, OPTY_ICON_LARGE corresponds to the “Opportunities” icon 904, 1004, and 1104 shown in FIGS. 9-11, respectively.

Resource selection logic 1204, in one embodiment, generates a list of candidate keys for the selected resource identifier as shown in step 1310. Each key is generated as a function of the context, or a portion thereof, and the selected resource identifier. In one embodiment, the keys are listed in order or precedence from top to bottom. For purposes of explanation, the key with the highest precedence is determined to be the most qualified candidate key. The first key on the list is presumed to have the highest precedence and is derived by concatenating the full context with the selected resource identifier. The next key on the list is presumed to have the next highest precedence and is derived by dropping the last component of the prior key. This process continues until only the resource identifier is left, which is designated as the last key of the list, and which will have the lowest precedence. With OPTY_ICON_LARGE selected as the resource identifier, and with RIM.BLACKBERRY.BOLD as the context, resource selection logic 1204 would generate the following list of four candidate keys:

OPTY_ICON_LARGE.RIM.BLACKBERRY.BOLD

OPTY_ICON_LARGE.RIM. BLACKBERRY

OPTY_ICON_LARGE.RIM

OPTY_ICON_LARGE

In step 1312, the first key or the key with the highest precedence is selected from the candidate list. In the illustrated example, OPTY_ICON_LARGE.RIM.BLACKBERRY.BOLD is selected in step 1312. In step 1316, the currently selected key is compared with keys in memory 212 to determine if a match exists. If a match is identified, the pointer mapped to the matching key is used to select the corresponding resource, which is subsequently added to the reply as shown in step 1320. If no match exists, the method proceeds to step 1322 where the key with the next highest precedence is selected from the candidate list in memory 1206, and step 1316 is repeated. Eventually, a key in the candidate list will match a key in memory 212, and the corresponding resource will be added to the reply. In the illustrated example, OPTY_ICON_LARGE.RIM.BLACKBERRY from the candidate list above is the key with the highest precedence that matches a key in memory 212, and accordingly the resource identified by/images/opty_50×50.png is selected for addition to the reply.

In step 1330 resource selection logic 1204 determines whether additional resource identifiers are contained within the page definition in memory 1204. If no more resource identifiers exist, the process ends. Otherwise, the next resource identifier is selected in step 1332 and the process begins again with step 1310 as shown in FIG. 13. Ultimately, when resource selection logic 1204 completes the process shown in FIG. 13, all resources for the reply should have been selected. The reply can then be serialized and sent to the mobile device (e.g., mobile device 102) that sent the request of step 1302.

FIG. 14 depicts a block diagram of a computer system 1410 suitable for implementing the present disclosure. Computer system 1410 may be illustrative of various computer systems (e.g., servers or clients) shown in FIGS. 1 and 2. Computer system 1410 includes a bus 1412 which interconnects major subsystems of computer system 1410, such as a central processor 1414, a system memory 1417 (typically RAM, but which may also include ROM, flash RAM, or the like), an input/output controller 1418, an external audio device, such as a speaker system 1420 via an audio output interface 1422, an external device, such as a display screen 1424 via display adapter 1426, serial ports 1428 and 1430, a keyboard 1432 (interfaced with a keyboard controller 1433), a storage interface 1434, a floppy disk drive 1437 operative to receive a floppy disk 1438, a host bus adapter (HBA) interface card 1435A operative to connect with a Fibre Channel network 1490, a host bus adapter (HBA) interface card 1435B operative to connect to a SCSI bus 1439, and an optical disk drive 1440 operative to receive an optical disk 1442. Also included are a mouse 1446 (or other point-and-click device, coupled to bus 1412 via serial port 1428), a modem 1447 (coupled to bus 1412 via serial port 1430), and a network interface 1448 (coupled directly to bus 1412).

Bus 1412 allows data communication between central processor 1414 and system memory 1417, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1410 are generally stored on and accessed via a computer readable medium, such as a hard disk drive (e.g., fixed disk 1444), an optical drive (e.g., optical drive 1440), a floppy disk unit 1437, or other storage medium. Additionally, applications can be in the form of electronic signals modulated in accordance with the application and data communication technology when accessed via network modem 1447 or interface 1448.

Storage interface 1434, as with the other storage interfaces of computer system 1410, can connect to a standard computer readable medium for storage and/or retrieval of information, such as a fixed disk drive 1444. Fixed disk drive 1444 may be a part of computer system 1410 or may be separate and accessed through other interface systems. Modem 1447 may provide a direct connection to a remote server via a telephone link or to the Internet via an internet service provider (ISP). Network interface 1448 may provide a direct connection to a remote server via a direct network link to the Internet via a POP (point of presence). Network interface 1448 may provide such connection using wireless techniques, including digital cellular telephone connection, Cellular Digital Packet Data (CDPD) connection, digital satellite data connection or the like.

The operation of a computer system such as that shown in FIG. 14 is readily known in the art and is not discussed in detail in this application. Code for implementing a CRM can be stored in computer-readable storage media such as one or more of system memory 1417, fixed disk 1444, optical disk 1442, or floppy disk 1438. Memory 1420 is also used for storing temporary variables or other intermediate information during the execution of instructions by the processor 1410. The operating system provided on computer system 1410 may be MS-DOS®, MS-WINDOWS®, OS/2®, UNIX®, Linux®, or another known operating system.

Although the invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
receiving a page request from a mobile device, wherein the page request comprises data;
in response to receiving the page request, selecting a page definition, wherein the page definition comprises one or more resource identifiers;
selecting a first identifier from the one or more identifiers;
creating a first key as a function of the first identifier and the data or a portion thereof;
selecting a first resource that is mapped directly or indirectly to the first key;
generating a reply to the request, wherein the reply comprises the first resource.

2. The method of claim 1 further comprising:
selecting another identifier from the page definition;
creating another key as a function of the other identifier and the data or the portion thereof;
selecting another resource that is mapped directly or indirectly to the other key;
wherein the reply comprises the other resource.

3. The method 1 wherein the data identifies a mobile device type.

4. The method of claim 1 wherein the page definition is selected from a plurality of page definitions based on information of the page request.

5. The method of claim 1 further comprising:
creating a first list of keys, wherein the list comprises the first key and a second key, wherein the second key is created as a function of the first identifier and the data or the portion thereof;
ordering the first list of keys;
wherein selecting the first resource comprises comparing the first key with a plurality of keys in a memory structure to identify a key in the memory structure that matches the first key;
wherein the key in the memory structure that matches the first key is directly or indirectly mapped to the key.

6. The method of claim 5 further comprising an act of comparing the second key with the plurality of keys in the memory structure.

7. The method of claim 1 further comprising:
serializing the reply;
transmitting the serialized reply to the mobile device;
the mobile device displaying a page in response to receiving the serialized reply.

8. A method comprising:
receiving a first page request from a first mobile device;
selecting a page definition in response to receiving the first page request;
selecting a first set of resources using data contained in the first page request and data contained in the page definition;
generating a first reply that comprises the first set of resources;
sending the first reply to the first mobile device;
receiving a second page request from a second mobile device;
selecting the page definition in response to receiving the second page request;
selecting a second set of resources using data contained in the second page request and the data contained in the page definition, wherein the second set is distinct from the first set;
generating a second reply that comprises the second set of resources;
sending the second reply to the second mobile device.

9. A computer readable medium comprising instructions, wherein a method is implemented in response to executing the instructions, the method comprising:
wherein the page request comprises data;
in response to receiving a page request from a mobile device, selecting a page definition, wherein the page definition comprises one or more resource identifiers;
selecting a first identifier from the one or more identifiers;
creating a first key as a function of the first identifier and data of the page request or a portion of the data of the page request;
selecting a first resource that is mapped directly or indirectly to the first key;
generating a reply to the request, wherein the reply comprises the first resource.

10. The computer readable medium of claim 9 wherein the method further comprises:
selecting another identifier from the page definition;
creating another key as a function of the other identifier and the data or the portion thereof;
selecting another resource that is mapped directly or indirectly to the other key;
wherein the reply comprises the other resource.

11. The computer readable medium 9 wherein the data identifies a mobile device type.

12. The computer readable medium 9 wherein the page definition is selected from a plurality of page definitions based on information of the page request.

13. The computer readable medium of claim 9 further comprising:
creating a first list of keys, wherein the list comprises the first key and a second key, wherein the second key is created as a function of the first identifier and the data or the portion thereof;
ordering the first list of keys;
wherein selecting the first resource comprises comparing the first key with a plurality of keys in a memory structure to identify a key in the memory structure that matches the first key;
wherein the key in the memory structure that matches the first key is directly or indirectly mapped to the key.

14. The computer readable medium of claim 13 wherein the method further comprises an act of comparing the second key with the plurality of keys in the memory structure.

15. The computer readable medium 9 further comprising:
serializing the reply;
transmitting the serialized reply to the mobile device.

16. A computer readable medium comprising instructions, wherein a method is implemented in response to executing the instructions, the method comprising:
selecting a page definition in response to receiving a first page request from a first mobile device;
selecting a first set of resources using data contained in the first page request and data contained in the page definition;
generating a first reply that comprises the first set of resources;
sending the first reply to the first mobile device;
selecting the page definition in response to receiving a second page request from a second mobile device;
selecting a second set of resources using data contained in the second page request and the data contained in the page definition, wherein the second set is distinct from the first set;
generating a second reply that comprises the second set of resources;
sending the second reply to the second mobile device.

17. The computer readable medium of claim 16 wherein the data of the first page request identifies the first mobile device by type.

18. The computer readable medium of claim 16:
wherein the data of the first page request identifies the first mobile device by type;
wherein the data of second page request identifies the second mobile device by type;
wherein the data of the first page request is distinct from the data of the second page request.

19. The computer readable medium of claim 16 wherein the first resource comprises a first file that contains data for a first image, and wherein the second resource comprises a second file that contains data for a second image that is distinct from the first image.

20. The computer readable medium of claim 16 wherein the method further comprises creating a first key as a function of the first identifier and the data of the first page request or a portion thereof, and selecting the first resource that is mapped directly or indirectly to the first key.
